(19) United States
(12) Patent Application Publication
(10) Pub. No.: US 2020/0258024 A1
(43) Pub. Date: Aug. 13, 2020

(54) IDENTIFYING AVAILABLE CARGO VEHICLES

(71) Applicant: Slingshot, LLC, Salt Lake City, UT (US)

(72) Inventors: Mark Haslam, Bountiful, UT (US); Brendan Marshall, Sandy, UT (US); Jan DeHoop, Sandy, UT (US)

(21) Appl. No.: 16/749,616

(22) Filed: Jan. 22, 2020

Related U.S. Application Data
(60) Provisional application No. 62/802,412, filed on Feb. 7, 2019.

(51) Int. Cl. G06Q 10/06; G07C 5/00; G06Q 10/08; H04W 4/029

(52) U.S. Cl. CPC G06Q 10/06398; G07C 5/008; H04W 4/029; G06Q 10/0833; G06Q 10/06313

(57) ABSTRACT

In one example in accordance with the present disclosure, a method for identifying an available cargo vehicle is described. According to the method, a time when a cargo tractor is scheduled to be available is determined as well as a location where the cargo tractor is scheduled to be available. Characteristics of a cargo trailer coupled to the cargo tractor are determined and an available number of hours left to drive for a driver associated with the cargo tractor are also determined. Time information, location information, cargo trailer characteristic information, and driver availability information for multiple cargo vehicles is aggregated in a database.

### BACKGROUND

Trucking devices are used world-wide to deliver goods across the globe. One need not look very far to find a product that was placed in a shipping container and transported over land via a cargo truck. Given the growth of commerce worldwide, it can be presumed with certainty that the shipping industry, and specifically land-hauling tractor-trailers will play a greater and more relevant role in society.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a flow chart of a method of identifying available cargo vehicles, according to an example of the principles described herein.

FIG. 2 is a block diagram of a system for identifying available cargo vehicles, according to an example of the principles described herein.

FIG. 3 is a diagram of the system for identifying available cargo vehicles, according to an example of the principles described herein.

FIG. 4 is a flow chart of a method of identifying available cargo vehicles, according to another example of the principles described herein.

FIG. 5 is a block diagram of a system for identifying available cargo vehicles, according to another example of the principles described herein.

FIG. 6 is a block diagram of a system for identifying available cargo vehicles, according to another example of the principles described herein.

FIG. 7 depicts a non-transitory machine-readable storage medium for identifying available cargo vehicles, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

The ability to ship goods across the globe is essential to the global economy we live in today. Different areas of the world specialize in producing different types of goods. For example, some locations have environmental conditions that enable the growth of certain produce. Other locations, while not suitable for certain produce harvest, may be uniquely qualified to produce certain manufactured goods. The shipping industry allows these goods to be transported from where they are manufactured, to locations across the globe where they are made available to consumers. Container ships transport the goods across the oceans and cargo trucks, among other vehicles, transport the goods across the land.

While the use of cargo vehicles has undoubtedly shaped modern society and is directly related to the interconnectedness of commercial society, improvements to the shipping network and worldwide shipping fleet may increase the ability to effectively and quickly disseminate goods around the globe. For example, to haul a load, a producer or a freight broker has to locate a cargo trailer to hold a shipment, a cargo tractor to take the cargo trailer to its intended destination, and a driver to drive the shipment to that location. With cargo tractors/drivers spread out across a landmass, it may be difficult to identify a cargo tractor/driver that is available and near the location from where the goods are to be shipped. The time to identify a suitable tractor/driver may delay the shipment and therefore delay getting the goods into a consumer's hands.

Accordingly, the present specification describes a system and method to increase the efficiency of determining when and where certain cargo tractors are available for use in hauling a particular load. Specifically, via a user interface, a driver may be queried as to the location and date on which they are scheduled to drop off a particular load, without a subsequent load planned. Such information may be gathered for a number of tractor/driver pairs and uploaded to a database. A freight broker, or an owner of a shipment, may access the database to identify a tractor/driver pair near the origin of a shipment they have. Thus, rather than having to haphazardly look for an available transport in the vicinity, the present system and method identify a large source of available cargo tractors/drivers from which to select a suitable match based on the load to be hauled.

In one specific example, a group of user questions are presented that relate to the time of availability, the geographic location of availability and the type of trailer that is available. The questions are presented to the driver on a computing device disposed within the cargo tractor. Answers are provided to a remote database. This volunteered information is then combined with other information that is available at the remote database, such as the remaining hours of driving the driver has available. This information is then aggregated with similar information from other tractor/trailer combinations to create a dynamic list or table of tractor/trailers and drivers that are potentially available for loads within certain time windows and geographic areas. The database is then made available to freight brokers and other third parties such that they may contact the managers of these assets (tractors/trailers/drivers) to negotiate a freight contract for a load.

Specifically, the present specification describes a method for identifying an available cargo vehicle. According to the method a time when a cargo tractor is scheduled to be available is determined as is a location where the cargo tractor is scheduled to be available. Characteristics of a cargo trailer coupled to the cargo tractor are also determined. An available number of hours left to drive for a driver associated with the cargo tractor is also determined. Time information, location information, cargo trailer characteristic information, and driver availability information for multiple cargo vehicles are aggregated in a database.

The present specification also describes a system. The system includes an availability determiner. The availability determines includes 1) a time determiner to determine a time when a cargo tractor is scheduled to be available, 2) a location determiner to determine a location where the cargo tractor is scheduled to be available, 3) a characteristics determiner to determine characteristics of a cargo trailer coupled to the cargo tractor, and 4) a driver availability determiner to determine an available number of hours left to drive for a driver associated with the cargo tractor. The system also includes a transceiver to transmit information from the cargo tractor. A database of the system includes time information, location information, cargo trailer characteristic information, and driver availability information for multiple cargo tractors.

The present specification also describes a non-transitory machine-readable storage medium encoded with instructions executable by a processor. The machine-readable storage medium includes instructions to determine availability information for a number of cargo tractors. The availability information includes 1) a time when a cargo tractor is scheduled to be available, 2) a location where the cargo tractor is scheduled to be available, 3) characteristics of a cargo trailer coupled to the cargo tractor, and 4) an available number of hours left to drive for a driver associated with the cargo tractor. The machine-readable storage medium also includes instructions to aggregate availability information for the number of cargo tractors in a database and to determine current global positioning information for the cargo tractor. The machine-readable storage medium also includes instructions to 1) receive search criteria related to a load to be hauled and 2) compare the availability information with the search criteria. The machine-readable storage medium also includes instructions to, based on results of a comparison and the current global positioning information for each cargo trailer, identify potential cargo tractors to haul the load.

In another example, a cargo vehicle availability system includes an electronic logging device (ELD) disposed in a cargo tractor. The ELD includes a log tracker that logs a tractor driver's hours and an interface. The interface 1) presents a first question to determine a time when a cargo tractor is scheduled to be available, 2) presents a second question to determine a location where the cargo tractor is scheduled to be available, and 3) presents a third question to determine characteristics of a cargo trailer coupled to the cargo tractor. A transceiver in the cargo tractor transmits information from the cargo tractor to a remote location. The system also includes an availability determiner at the remote location. The availability determiner includes the time determiner, the location determiner, the characteristics determiner, and the driver availability determiner. A database at the remote location stores, for multiple cargo tractors, information relating to an answer to the first question, an answer to the second question, an answer to the third question and driver availability information.

In summary, using such a system and method 1) provides for the tracking of cargo vehicles available for use in hauling a load, 2) centralizes availability information for multiple cargo vehicles, 3) reduces downtime of cargo tractors; and 4) decreases wait time for a cargo vehicle. However, the devices disclosed herein may address other matters and deficiencies in a number of technical areas.

As used in the present specification and in the appended claims, the term “cargo tractor” or “tractor” refers to a towing engine that moves a trailered vehicle. In some examples, such a cargo tractor may be referred to as a tractor unit, a prime mover, or a semi-truck.

Further, as used in the present specification and in the appended claims, the term “cargo trailer” or “trailer” refers to a trailered vehicle that receives a load. In some examples, such a cargo trailer may be an enclosed semi-trailer. However, a cargo trailer may refer to any wheeled vehicle, whether powered or not, that is pulled by a cargo tractor.

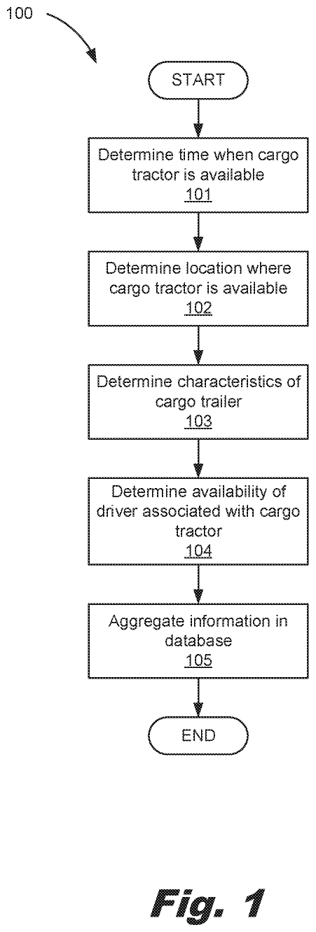

Turning now to the figures, FIG. 1 is a flow chart of a method (100) of identifying available cargo vehicles, according to an example of the principles described herein. Specifically, the current method (100) describes the identification of a tractor that is available, whether the driver of that tractor is available, and whether a trailer to haul the load is available. Not only does the present method (100) determine what cargo vehicles are available, i.e., not currently used, but also determines whether a particular tractor/driver pair are available within a reasonable time frame of when they are needed and within a reasonable distance from the site of origin of the load.

To do so, a time when the cargo tractor is available is determined (block 101). In this context, available refers to an unloaded tractor, i.e., one that is not on a haul job. Accordingly, determining (block 101) a time when the cargo tractor is available may include determining when the cargo tractor is scheduled to finish its current load. Such time information may be presented at different resolutions. For example, it may be a date, a range of dates, or even a specific hour of a specific date. For example, the time when a particular cargo tractor is scheduled to be available may be June 2^{nd}. In another example, it may be a range of dates, such as that the tractor will be available sometime between June 7^{th} and June 9^{th}. As yet another example, the date may be a particular hour such as 2:00 pm Sept. 4^{th}. This information allows a freight broker, or an owner of cargo to be shipped, to determine if the availability of the cargo tractor aligns with when the load needs to be shipped.

In addition to determining (block 101) a time when a cargo tractor is available, the method (100) also includes determining (block 102) a location where the cargo tractor is scheduled to be available. In general, this may mean the location where a current load is to be unloaded. Again, this information may be determined at any resolution, such as a particular region, state, or address. For example, the location where a cargo trailer is to drop off its current load and is therefore available may be Athens, Ga. This information allows a freight broker, or an owner of cargo to be shipped, to determine if the location where the cargo trailer will be available is near enough to the origin site of the load.

In some examples, the characteristics of a cargo tractor/trailer are also determined (block 103). That is, different cargo tractors have different characteristics such as engine power. The engine power determines how much weight a particular tractor can haul. Accordingly, such information allows a freight broker, or other entity in need of a cargo carrier, to determine if a cargo tractor that is available, is capable of hauling a particular load. While specific reference is made to particular cargo tractor characteristics, other characteristics may also be determined, which other characteristics may impact whether a particular cargo tractor is capable/desired for a particular haul.

In addition to determining (block 103) characteristics of a cargo tractor, characteristics of the cargo trailer may also be determined. For example, certain cargo trailers have refrigeration units and are therefore capable of shipping frozen goods. Again, this information is relevant to the determination about whether a particular cargo tractor/driver/trailer is capable of handling the shipping requirements of a particular load. While specific reference is made to one particular cargo trailer characteristic, other characteristics may also be determined, which other characteristics may impact whether a particular cargo trailer is capable/desired for a particular haul.

In addition to determining information relating to the equipment used for a haul, information may also be determined related to a driver of the cargo tractor. For example, the method (104) may include determining an available number of hours left to drive for a driver associated with the cargo tractor. That is, shipping fleet requirements, legal requirements, or other factors may limit the amount of time a driver can continuously helm a cargo tractor. If a driver is up against the limit, it may not matter that a particular cargo tractor/trailer is available to haul a load as there would be no driver to man the vehicle. Accordingly, this information is again useful in allowing a shipment provider to determine a combination of driver/tractor/trailer to haul their shipment.

All this information is aggregated (block 105) into a database. That is, a central database may include availability information for a variety of cargo tractors, which availability information includes time information, location information, cargo trailer characteristic information, and driver availability information. As a specific example, one entry may indicate that a medium-sized cargo tractor is available on August 23^{rd} near Tampa Fla. and that the driver has 15 hours before his mandated period of rest. This type of information may be collected from a variety of sources such that the database includes thousands of entries for different cargo tractors across the country to facilitate effective identification of potential cargo carriers that suit the shipping requirements of a particular load. In some examples, the database is a searchable database. That is, third parties, such as shipment providers or shipment brokers, can access the database and use criteria to determine which of the plethora of cargo tractors best suits their needs.

The information, i.e., time information, location information, trailer characteristic information, and driver availability information may be collected in a variety of ways. For example, any one of 1) the time when a cargo tractor is scheduled to be available, 2) the location where a cargo tractor is scheduled to be available, 3) characteristics of the cargo trailer, and 4) an available number of hours left to drive for a driver associated with the cargo tractor may be determined based on a driver answering questions. That is, each cargo tractor may be equipped with a computing device that includes a user interface. A series of questions may be presented to a user via the user interface. The answers to these questions may allow a system to determine the time information, location information, and characteristics of the cargo trailer. For example, the questions may include “when are you scheduled to complete your current load,” “where are you scheduled to unload your current load,” and “what type of cargo trailer are you currently attached to.” The answers to these questions may be made in a variety of formats. For example, a driver may select from a number of available answer choices, or may be allowed to type in an answer. While specific reference is made to particular questions, questions of different format may be presented to the user for selection and answering.

In some examples, the questions are presented, along with others, at the start of a delivery haul. Doing so at the beginning of a delivery haul may increase the efficiency of a system. That is, rather than a driver indicating an immediate availability, a driver can indicate future availability, thus allowing a shipment provider time to plan and to negotiate with the fleet manager.

Similarly, the questions may be presented at the beginning of a driving day. Presenting such questions at the beginning of a driving day, allows the database to be updated due to change in circumstances that may occur. That is, a daily presentation of questions may allow the system to re-calibrate on a daily basis.

In another example, any one of 1) the time when a cargo tractor is scheduled to be available, 2) the location where a cargo tractor is scheduled to be available, 3) characteristics of the cargo trailer, and 4) an available number of hours left to drive for a driver associated with the cargo tractor may be determined by analyzing log records from a computing device disposed in the cargo tractor.

That is, as described above, each cargo tractor may include a computing device. Such a computing device may include tracking data. For example, a user may input their available hours before a mandated break, a trailer type, and a planned route. From this information, a system can extract the availability time, availability location, trailer characteristics, and driver availability. In either case, i.e., user answering questions and/or analysis from log records, the collected information is aggregated (block 105) in a database where it is searchable by cargo brokers, cargo providers, or any other third party.

It should be noted that different pieces of information may be collected via different methods. For example, time availability information, location availability information, and trailer characteristics may be acquired via user questions while driver availability information may be extracted, or may be collected by the system (200) via another source, such as from fleet management computing devices.

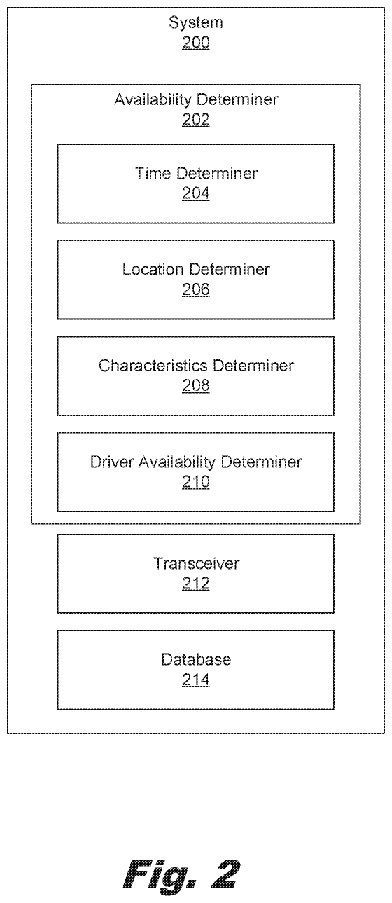

FIG. 2 is a block diagram of a system (200) for identifying available cargo vehicles, according to an example of the principles described herein. The system (200) may include any number of hardware components such as processor(s) and memory device(s). Specifically, the system (200) includes an availability determiner (202). In general, the availability determiner (202) determines when a cargo tractor/trailer is available as well as a driver associated with the cargo tractor/trailer. Specifically, the availability determiner (202) provides information such as when a tractor is available, i.e., not-scheduled, a location where the tractor is expected to be when available, and characteristics of a trailer coupled to the tractor. The availability determiner (202) also provides information about the availability of a driver to helm the cargo tractor/trailer.

Specifically, the availability determiner (204) includes a time determiner (206) to determine a time when a cargo tractor is scheduled to be available. A location determiner (206) determines a location where the cargo tractor will be when available. A characteristics determiner (208) determines characteristics of the cargo trailer coupled to the cargo tractor and a driver availability determiner (210) determines an available number of hours left to drive for a driver associated with the cargo tractor.

As described above, the determiners may receive the information as responses to questions. That is, a user interface may present different questions to a driver. The driver's answers to these questions are received and parsed into information that can be populated into a database for subsequent search.

In another example, the determiners receive the raw data from a log record. That is, the log record may include planned hauls and may also track the hours a driver has available before a mandated break. In this example, each determiner may extract relevant information, and upload this information into the database (214). In this example, the availability determiner (202) collects information without user input.

The system (200) also includes a transceiver (212) to transmit information from the cargo tractor. That is, the computing device in the cargo tractor may be communicatively coupled to a remote station such that information, be it answers to questions and/or log records, can be passed to the remote location for upload to the database (214).

The database (214) in these examples may be updateable. That is, tractors and trailers are constantly on the move across the map such that their data may change. The database (214) may be updated to reflect this. For example, in the database (214) a particular entry for a truck may indicate its availability on March 3^{rd} near Boise Id. However, a broker may schedule that tractor for a delivery to begin on March 5^{th}. Accordingly, the availability of the truck, based on newly entered log information on March 5^{th}, or based on questions asked to the truck driver on March 5^{th} as he prepares to embark on that haul, may be updated in the database. Thus, the present system (200) not only provides a database of availability of a number of cargo tractors, but also provides up-to-date information in that database.

The form in which the transceiver (212) communicates may be of a variety of types. For example, a mobile communication telematic device may be a computer that is connected to a tractor and includes as a core function, an electronic logging operation. In this example, the computer includes a cellular modem or other wireless transmitter, such as a wi-fi transmitter. The computer is enabled to communicate to a network operation center where resides the database (214) that stores information sent by the transceiver(s) (212) of multiple cargo tractors. The database (214) provides a means to digitally display various tables of information received simultaneously from the many computers of many tractors. The system (200) includes specific information from the questionnaire along with other information to create a user interactive table that can be made available to freight brokers or other third parties via authentication. The database (214) shows to the third parties, the tractors/trailers/drivers that plan to be empty and available in a certain geographic region at a certain time window. Using this information, freight brokers, shipment providers, or other third parties can identify tractors, trailers, and/or drivers that meet criteria for a particular shipment and can contact the fleet management to offer a load contract.

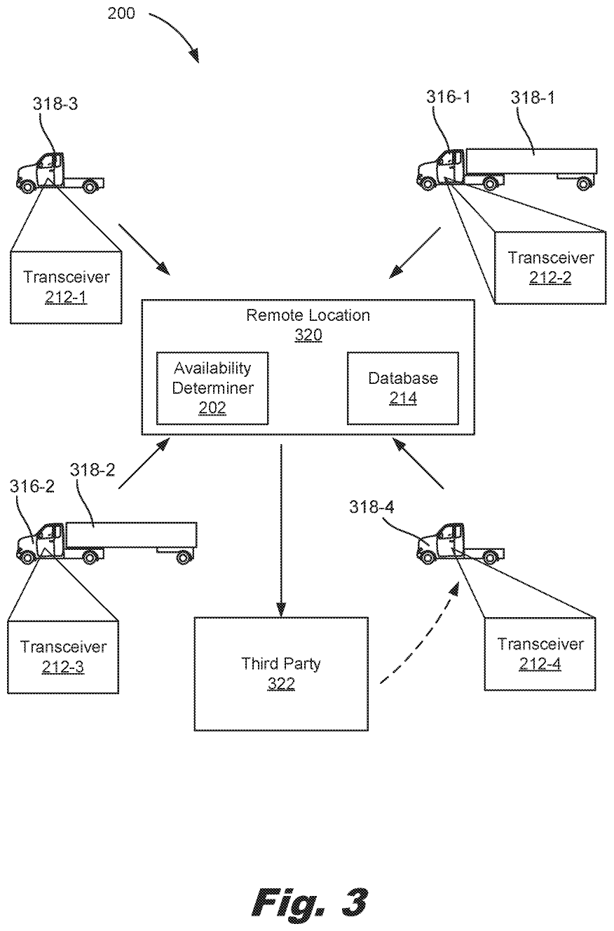

FIG. 3 is a diagram of the system (200) for identifying available cargo vehicles, according to an example of the principles described herein. As mentioned above, loads may be hauled by cargo vehicles which include a tractor (316) that provides the towing power and a trailer (318) which holds the cargo to be hauled. At any given point different tractors (316) may be free to take on new loads. In FIG. 3, tractors (316) that are unencumbered are indicated without a trailer (318) attached. For example, a first tractor (316-1) and a second tractor (316-2) may be unavailable as indicated by the presence of a trailer (318-1, 318-2). Such unavailability may be for a number of reasons, such as being currently on a shipment route, in for repairs, driver unavailability due to being on a mandated break, etc. Other tractors (318) may be available such as the third tractor (318-3) and the fourth tractor (318-4) which are indicated as being available by the lack of an associated trailer.

As described above, the system (200) includes transceiver(s) (212) that transmit data. In one specific example, the database (214) and the availability determiner (202) are remote from the transceiver(s) (212). That is, each tractor (316) may include a computing unit that either 1) prompts drivers to enter availability information or 2) extracts availability information from uploaded data. This information is collected, processed by the availability determiner (202) and then stored in the database (214) at the remote location (320).

The information may then be made available to a third party (322). For example, a freight broker may be an intermediary between shipment providers and carriers. Accordingly, the freight broker may access the database (214), for example after authentication, to determine which of the listed cargo vehicles in the database (214) are potential carriers for a particular load. If the third party (322) finds a suitable cargo carrier, that third party (322) may reach out to the carrier management company to employ their services. Thus, the present system (200) provides a streamline process for identifying which cargo vehicles are well-suited to handle a particular load based on location and time of availability the type of cargo trailer, and the availability of the driver.

A specific example is now provided. In this example, a driver, at the beginning of a new trip or a new shift, brings up an application on a computing device disposed in the cargo tractor (316). In this example, the driver answers a series of provided questions including questions dedicated to the time and location of an unload and the type of trailer being used. The computing device transceiver (212) sends the driver's answers to these questions to the remote location (320) via a wireless data communication method such as a cellular communication or Wi-Fi communication.

The availability determiner (202) running at the remote location (320) takes and combines the answers with the driver's hours of service log data, the current GPS data, and other data and places the information into a database (214) combined with similar data from other drivers/tractors/trailers. In some examples, this information might be anonymous so that the third party (322) does not know the identity of the trucking company.

The third party (322) may gain access to the database (214) which lists many tractor/trailers via a sign-in process. After signing in, the third party (322) enters search criteria consistent with a particular load to be hauled. A list of the relevant assets (tractors/trailers/driver combinations) for a geographic area and time window and trailer type consistent with the search criteria is then presented to the third party (322). The third party (322) can then select one or more assets to offer the load to. The system then receives selection of one of the potential cargo tractors.

Following selection, a notification is sent to management personnel of a selected cargo tractor indicating that the third party (322) would like to offer a load contract. In this example, the carrier may contact the third party (322) to discuss the terms of the load contract. If a load contract is signed, an indication of such is made, and the database (214) updated to take the asset of the list.

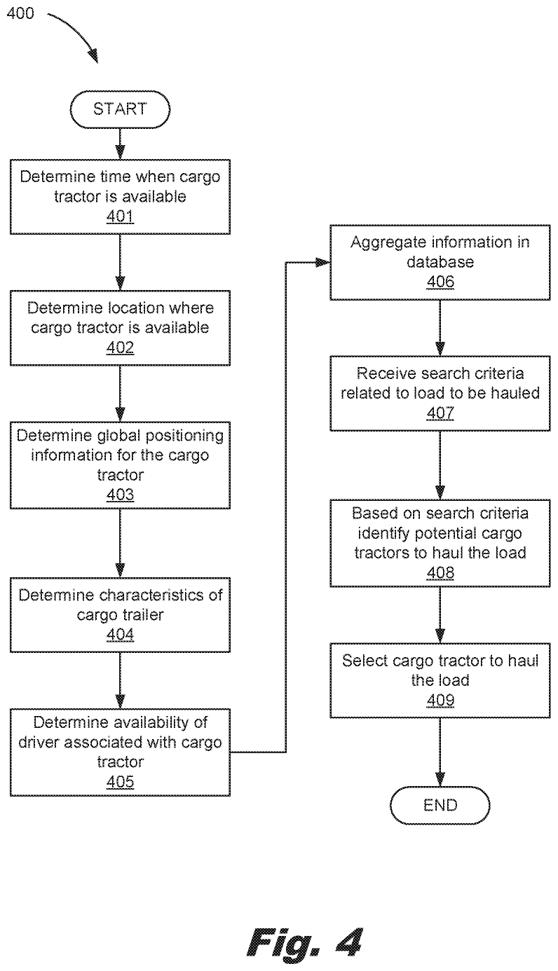

FIG. 4 is a flow chart of a method (400) of identifying available cargo vehicles, according to another example of the principles described herein. According to the method (400), a time and location when the cargo tractor is available are determined (blocks 401, 402). These operations may be performed as described above in connection with FIG. 1.

In an example, global positioning information for the cargo tractor (FIG. 3, 316) may also be determined (block 403). Specifically, the computing device that is included in the cargo tractor (FIG. 3, 316) may periodically or continually output global positioning information on the tractor. This information may be used to determine a suitable tractor/trailer to haul a future load. That is, the global positioning information may provide another data point by which it can be estimated whether a particular cargo tractor/trailer will be available.

The global positioning information may allow a third party (FIG. 3, 322) to track a particular tractor/trailer along its route. Such tracking allows the third party (FIG. 3, 322) to determine whether the tractor/trailer is likely to be available when scheduled. For example, the GPS information may allow the third party (FIG. 3, 322) to determine whether the tractor/trailer is on schedule to arrive at a destination at the appointed time. For example, a tractor may break down, indicating it will not be at the scheduled location at the scheduled time such that it will not be available to haul a particular load.

Characteristics of the cargo trailer and an availability of the driver associated with the cargo tractor are determined (blocks 404, 405) and the information aggregated (block 406) in the database (FIG. 2, 214). These also may be performed as described above in connection with FIG. 1.

As described above, subscribing third parties (FIG. 3, 322) may access the database (FIG. 2, 214) to identify suitable cargo carriers for a particular job. Accordingly, in this example the system (FIG. 2, 200) includes an interface that allows the third party (FIG. 3, 322) to enter search criteria.

Accordingly, the system (FIG. 2, 200) receives (block 407) the search criteria related to the load to be hauled. The search criteria may include any number of variables. For example, the search criteria may include a description of the load to be hauled. For example, identifying the load by type, i.e., produce, electronics, home goods, etc. The search criteria may also identify an origin of the load. For example, the address of where the cargo was manufactured, or currently sits. The search criteria may also include a shipping date for the load. This is the date on which a particular cargo is desired to be picked up and the transit initiated. In some examples, the shipping date may be a range or a particular date.

The search criteria may also indicate hauling requirements for the load. That is, particular loads may necessitate a cargo tractor or cargo trailer with particular characteristics. For example, frozen goods may require a refrigerated trailer and heavy loads may require a cargo tractor with a particular towing capacity. While specific mention is made of a few search criteria, any number of search criteria may be received (block 407) via an interface.

Based on the search criteria, a list of potential cargo tractors to haul the load are identified (block 408). Specifically, the list of potential cargo tractors to haul the cargo may be based on the alignment of the search criteria with information relating to the cargo tractors. For example, cargo tractors scheduled to be available at a certain date and at a certain location that align with an origin and desired shipment date may be identified as potential cargo tractors to haul that load. As yet another example, the cargo tractor characteristics may align with the hauling requirements for the load and thus indicate this cargo tractor as a potential candidate for hauling. Accordingly, any number of criteria may be received (block 407) and each cargo tractor that matches that criteria may be presented as a potential candidate for a cargo vehicle.

In addition to identifying (block 408) potential cargo tractors, the system (FIG. 2, 200) may actually select (block 409) a cargo tractor to haul the load. That is, in some examples the identification (block 408) of potential cargo tractors may be presented to a third party as well as contact information for the manager of the potential cargo tractor. In this example, the third party may have the responsibility of selection. In other examples, such as that depicted in FIG. 4, the system (FIG. 2, 200) itself may automatically select a cargo tractor that best satisfies the search criteria entered by the third party (FIG. 3, 322).

Thus, the present method (600) allows for the matching of available cargo tractors to shipping needs. Such a system simplifies and quickens the identification and selection process thus allowing deliveries to be more cost effective to the cargo provider and to allow the shipments to be delivered more quickly.

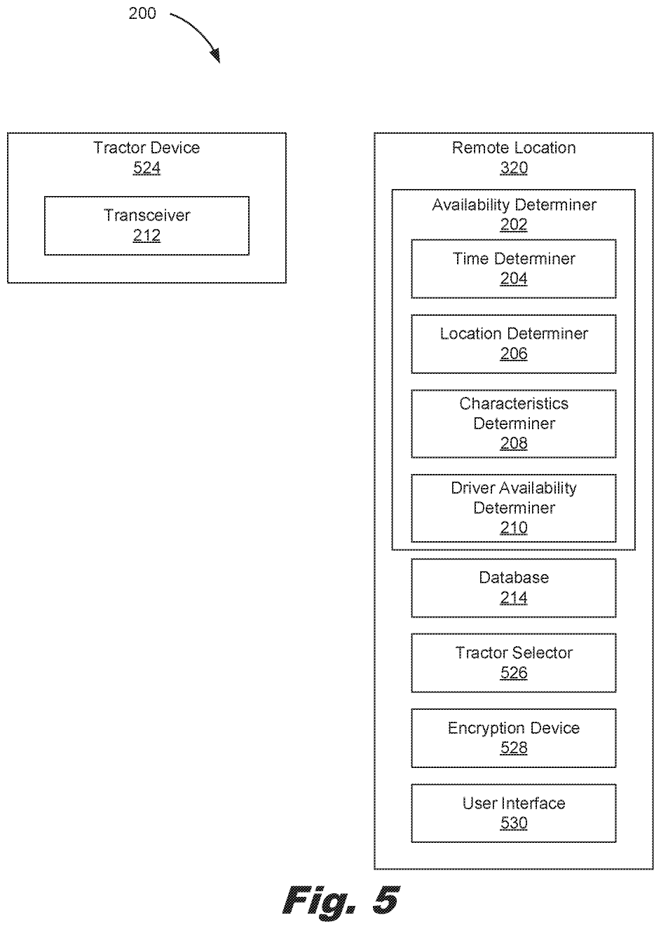

FIG. 5 is a block diagram of a system (200) for identifying available cargo vehicles, according to another example of the principles described herein. In some examples, the system (200) may be distributed meaning that certain components are on one computing device and others are on a different, or remote, computing device. In this example, the transceiver (212) is located on a tractor device (524). The tractor device (524) is the computing device described earlier that is located in the cargo tractor. The transceiver (212) transmits information to the availability determiner (202) which is disposed at a remote location (320). That is, as described above, driver answers or log record data may be passed to the availability determiner (202) which, based on the received information, determines a time and location of available cargo tractors and determines characteristics of the trailer as well as an availability of the driver of the cargo tractor.

In some examples, the remote location (320) device includes additional components. For example, the system (200) includes a tractor selector (526) that selects a particular cargo tractor and driver pair based on matching availability with a load to be hauled. That is, as described above, a comparison is made between search criteria that define a load to be hauled and the entries in a database (214). Based on this comparison, the system (200) may identify potential matches, and in some cases may select a particular tractor.

The system (200) may also include an encryption device (528) to remove identifying information of the driver associated with the cargo tractor. That is, the information stored in the database (214) may be sensitive in nature and the carriers that authorize their information to be included in the database (214) may desire a level of anonymity or security for the information they provide. The encryption device (528) provides the security by removing any identifying information prior to selection of a particular cargo tractor. Once a cargo tractor is selected however, information may be decrypted and provided to the third party (FIG. 3, 322) such that the third party (FIG. 3, 322) can reach out to the owner/manager of the cargo tractor to proceed with a business relationship.

The system (200) may also include a user interface (530) to allow third parties (FIG. 3, 322) to access the database (214). In some examples, the access may be subsequent to authentication. That is, a user may be prompted to enter a username and password prior to accessing the records contained in the database (214). Doing so provides yet another level of security to the information contained within the database (214). While specific reference is made to authentication via username and password, other forms of authentication may be used such as security keys.

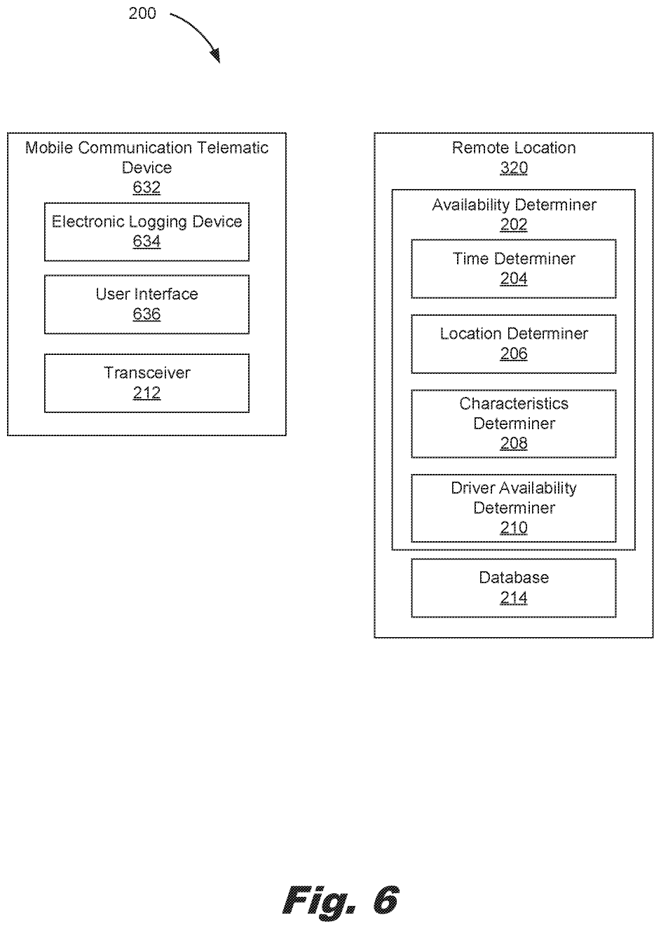

FIG. 6 is a block diagram of a system (200) for identifying available cargo vehicles, according to another example of the principles described herein. In this example, the system (200) is a distributed system including components both on the cargo tractor (FIG. 3, 316) as well as at the remote location (320).

Specifically, the system (200) includes a mobile communication telematic device (632) that has a variety of functionalities. The mobile communication telematic device (632) may include a processor and memory. As one of its functions, the mobile communication telematic device (632) may include an electronic logging device (ELD) (634). In some examples, the ELD (634) meets federal legal requirements for hours of service logs and therefore logs a driver's hours. That is, driving hours of commercial drivers may be regulated by a governmental entity. Accordingly, the ELD (634) tracks the hours of a driver to comply with these requirements. Specifically, the ELD (634) may track the daily and weekly hours spent driving and working, and track the amount of time drivers rest between driving shifts so as to ensure that each driver is complying with the government, or other entity, requirements.

The mobile communication telematic device (632) also includes a user interface (636) through which questions are presented to a driver. That is, through the user interface (636) a first question is presented to determine a time when the cargo tractor (FIG. 3, 316) is scheduled to be available. A second question is presented to determine a location where the cargo tractor is scheduled to be available and a third question is presented to determine characteristics of a cargo trailer (FIG. 3, 318) coupled to the cargo tractor. The mobile communication telematic device (632) also includes a transceiver (212) to transmit the answers from these questions from the cargo tractor (FIG. 3, 316) to the remote location (320).

Disposed at the remote location (320) are the availability determiner (202) with its specific determiners, as well as the database (214). In this example, the database stores information relating to answers to each question as well as driver availability information.

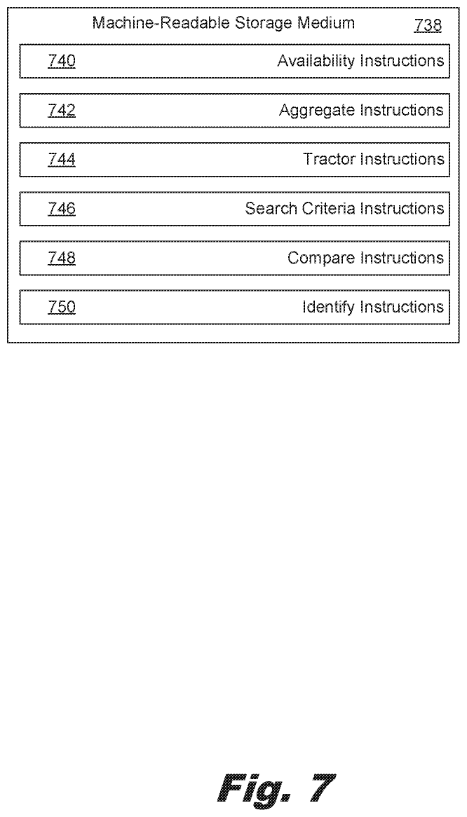

FIG. 7 depicts a non-transitory machine-readable storage medium (738) for identifying available cargo vehicles, according to an example of the principles described herein. To achieve its desired functionality, a computing system includes various hardware components. Specifically, a computing system includes a processor and a machine-readable storage medium (738). The machine-readable storage medium (738) is communicatively coupled to the processor. The machine-readable storage medium (738) includes a number of instructions (740, 742, 744, 746, 748, 750) for performing a designated function. The machine-readable storage medium (738) causes the processor to execute the designated function of the instructions (740, 742, 744, 746, 748, 750).

Referring to FIG. 7, availability instructions (740), when executed by the processor, cause the processor to determine availability information for a number of cargo tractors, the availability information including a time when a cargo tractor is scheduled to be available, a location where the cargo tractor is scheduled to be available, characteristics of a cargo trailer coupled to the cargo trailer and an available number of hours left to drive for a driver associated with the cargo tractor. Aggregate instructions (742), when executed by the processor, may cause the processor to, aggregate availability information for the number of cargo tractors in a database. Tractor instructions (744), when executed by the processor, may cause the processor to determine current global positioning information for the cargo tractor. Search criteria instructions (746), when executed by the processor, may cause the processor to receive search criteria related to a load to be hauled. Compare instructions (748), when executed by the processor, may cause the processor to compare the availability information with the search criteria. Identify instructions (750), when executed by the processor, may cause the processor to, based on results of a comparison and the current global positioning information for each cargo tractor, identify potential cargo tractors to haul the load.

In summary, using such a system and method 1) provides for the tracking of cargo vehicles available for use in hauling a load, 2) centralizes availability information for multiple cargo vehicles, 3) reduces downtime of cargo tractors; and 4) decreases wait time for a cargo vehicle. However, the devices disclosed herein may address other matters and deficiencies in a number of technical areas.

What is claimed is:

1. A method for identifying an available cargo vehicle, the method comprising:
determining a time when a cargo tractor is scheduled to be available;
determining a location where the cargo tractor is scheduled to be available;
determining characteristics of a cargo trailer coupled to the cargo tractor;
determining an available number of hours left to drive for a driver associated with the cargo tractor; and
aggregating time information, location information, cargo trailer characteristic information, and driver availability information for multiple cargo vehicles in a database.

2. The method of claim 1, wherein determining a time when a cargo tractor is scheduled to be available, determining a location where the cargo tractor is scheduled to be available, determining characteristics of a cargo trailer coupled to the cargo tractor, and determining an available number of hours left to drive for a driver associated with the cargo tractor are based on a driver answering questions presented on a user interface disposed in the cargo tractor.

3. The method of claim 2, wherein the questions are presented on the user interface at the start of at least one of:
a delivery haul; and
a beginning of a driving day.

4. The method of claim 1, wherein determining a time when a cargo tractor is scheduled to be available, determining a location where the cargo tractor is scheduled to be available, determining characteristics of a cargo trailer coupled to the cargo tractor, and determining an available number of hours left to drive for a driver associated with the cargo tractor are performed by analyzing log records from a computing device disposed in the cargo tractor.

5. The method of claim 1, wherein the database is a searchable database.

6. The method of claim 1, further comprising:
receiving search criteria related to a load to be hauled; and
based on the search criteria, identify a list of potential cargo tractors to haul the load.

7. The method of claim 6, wherein the search criteria includes at least one of:
a load to be hauled;
an origin of the load;
a shipping date for the load; and
hauling requirements for the load.

8. The method of claim 7, wherein identifying a list of potential cargo tractors to haul a particular load is based on an alignment of:
the time information for the cargo tractor and the shipping date for the load;
the location information for the cargo tractor and the origin of the load; and
the cargo trailer characteristic information and the hauling requirements for the load.

9. The method of claim 7, further comprising selecting a particular cargo tractor for use to haul the particular load.

10. The method of claim 1, further comprising determining current global positioning information for the cargo tractor.

11. A system, comprising:
an availability determiner comprising:
a time determiner to determine a time when a cargo tractor is scheduled to be available;
a location determiner to determine a location where the cargo tractor is scheduled to be available;
a characteristics determiner to determine characteristics of a cargo trailer coupled to the cargo tractor; and
a driver availability determiner to determine an available number of hours left to drive for a driver associated with the cargo tractor;
a transceiver to transmit information from the cargo tractor; and
a database comprising time information, location information, cargo trailer characteristic information, and driver availability information for multiple cargo tractors.

12. The system of claim 11, wherein the database and the availability determiner are at a remote location relative to the transceiver.

13. The system of claim 11, wherein the availability determiner collects information without user input.

14. The system of claim 11, further comprising a tractor selector that selects a particular cargo tractor and driver pair based on matching availability with a load to be hauled.

15. The system of claim 11, further comprising an encryption device to remove identifying information of the driver associated with the cargo tractor.

16. The system of claim 11, further comprising a user interface that allows third party access to the database following authentication.

17. The system of claim 11, wherein the database is updated based on updated outputs from the availability determiner.

18. A non-transitory machine-readable storage medium encoded with instructions executable by a processor, the machine-readable storage medium comprising:
instructions to determine availability information for a number of cargo tractors, the availability information comprising:
a time when a cargo tractor is scheduled to be available;
a location where the cargo tractor is scheduled to be available; and
characteristics of a cargo trailer coupled to the cargo tractor; and
an available number of hours left to drive for a driver associated with the cargo tractor;
instructions to aggregate availability information for the number of cargo tractors in a database;
instructions to determine current global positioning information for the cargo tractor;
instructions to receive search criteria related to a load to be hauled;
instructions to compare the availability information with the search criteria; and
instructions to, based on results of a comparison and current global positioning information for each cargo tractor, identify potential cargo tractors to haul the load.

19. The non-transitory machine-readable storage medium of claim 18, wherein the machine-readable storage medium comprises instructions to receive selection of one of the potential cargo tractors.

20. The non-transitory machine-readable storage medium of claim 18, wherein the machine-readable storage medium comprises instructions to, following selection by a user, send a notification to management personnel of a selected cargo tractor.

21. A system, comprising:
a mobile communication telematic device disposed in a cargo tractor comprising:
an electronic logging device that logs a tractor driver's hours; and
a user interface to:
present a first question to determine a time when a cargo tractor is scheduled to be available;
present a second question to determine a location where the cargo tractor is scheduled to be available; and
present a third question to determine characteristics of a cargo trailer coupled to the cargo tractor;
a transceiver to transmit information from the cargo tractor to a remote location;
an availability determiner at the remote location comprising:
a time determiner to determine a time when a cargo tractor is scheduled to be available;
a location determiner to determine a location where the cargo tractor is scheduled to be available;
a characteristics determiner to determine characteristics of a cargo trailer coupled to the cargo tractor; and
a driver availability determiner to determine an available number of hours left to drive for a driver associated with the cargo tractor;
a database at the remote location to store, for multiple cargo tractors, information relating to:
an answer to the first question;
an answer to the second question;
an answer to the third question; and
driver availability information.
